(19) United States
(12) Patent Application Publication
(10) Pub. No.: US 2026/0161572 A1
(43) Pub. Date: Jun. 11, 2026

(54) POWER-AWARE CACHE REPLACEMENT POLICY

(71) Applicant: QUALCOMM Incorporated, San Diego, CA (US)

(72) Inventors: Hiral NANDU, South San Francisco, CA (US); Subbarao PALACHARLA, San Diego, CA (US); Vinod Mohan GEORGE, Bangalore (IN); Tarun SOLANKI, Bhopal (IN); Prathamesh Dilip PATEL, San Diego, CA (US)

(21) Appl. No.: 18/972,581

(22) Filed: Dec. 6, 2024

(51) Int. Cl. G06F 12/126; G06F 12/0871

(52) U.S. Cl. CPC G06F 12/126; G06F 12/0871

(57) ABSTRACT

A processor-implemented method for power-aware cache replacement includes receiving a request associated with a data transaction directed to a cache memory. A cache miss is determined to have occurred based on the data transaction. A portion of the cache memory is allocated for replacement in accordance with the data transaction based on a power state of the portion of the cache memory.

### BACKGROUND

### Field

Aspects of the present disclosure relate to computing devices, and more specifically to a power-aware cache replacement policy.

### Background

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

Cache memories may be employed to boost the performance of computing devices by reducing access time to certain data relative to storing the data in slower storage, such as main memory. Large cache memories (e.g., 20 megabytes (MB) or 40 MB) may be employed in various applications to meet power targets for mobile computing devices, which may have limited power and computing resources. However, as the size of the cache memories increase, the memory leakage power may increase, resulting in a significant portion of power being consumed in operating the cache memories. As such, using cache memory in such resource limited compute devices may be challenging.

### SUMMARY

Various aspects of the present disclosure are directed to an apparatus. The apparatus has at least one memory and a memory management unit coupled to the at least one memory. The memory management unit is configured to receive a request associated with a data transaction directed to a cache memory of the at least one memory. The memory management unit is also configured to determine that a cache miss has occurred based on the data transaction. The memory management unit is further configured to allocate a portion of the cache memory for replacement in accordance with the data transaction based on a power state of the portion of the cache memory.

In various aspects of the present disclosure, a processor-implemented method includes receiving a request associated with a data transaction directed to a cache memory of the at least one memory. The processor-implemented method also includes determining that a cache miss has occurred based on the data transaction. The processor-implemented method further includes allocating a portion of the cache memory for replacement in accordance with the data transaction based on a power state of the portion of the cache memory.

Various aspects of the present disclosure are directed to an apparatus. The apparatus includes means for receiving a request associated with a data transaction directed to a cache memory of the at least one memory. The apparatus also includes means for determining that a cache miss has occurred based on the data transaction.

The apparatus further includes means for allocating a portion of the cache memory for replacement in accordance with the data transaction based on a power state of the portion of the cache memory.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), in accordance with certain aspects of the present disclosure.

FIG. 2 is a block diagram illustrating an example computing system, in accordance with various aspects of the present disclosure.

FIG. 3 is a block diagram illustrating an example architecture of memory, in accordance with various aspects of the present disclosure.

FIG. 4 is a block diagram illustrating an example memory layout of cache memories, in accordance with various aspects of the present disclosure.

FIG. 5 is a block diagram illustrating an example implementation of activity-based data random access memory (RAM) retention, in accordance with various aspects of the present disclosure.

FIG. 6 is a block diagram illustrating an example power state finite state machine (FSM), in accordance with various aspects of the present disclosure.

FIG. 7 is a block diagram illustrating an example of power-aware cache replacement, in accordance with various aspects of the present disclosure.

FIG. 8 is a flow diagram illustrating an example process for power-aware cache replacement, in accordance with various aspects of the present disclosure.

FIG. 9 is a flow diagram illustrating an example process for power-aware cache replacement, performed, for example, by a processor, in accordance with various aspects of the present disclosure.

FIG. 10 is a block diagram showing an exemplary wireless communications system in which a configuration of the present disclosure may be advantageously employed.

FIG. 11 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced.

The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Mobile or portable computing devices include mobile phones, laptop, palmtop, and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

Cache memories may be employed to boost the performance of computing systems by reducing access time to certain data relative to storing the data in slower storage such as main memory.

Cache memories may include three different types: level one (L1) cache, level two (L2) cache, and level three (L3) cache. The L1 cache may be considered the fastest memory present in a computing system (e.g., may be 100 times faster than main memory). The L1 cache may store data that the processor may most likely use while completing a specific task. The L1 cache may be split into an instruction cache and a data cache, in which the instruction cache includes instructions that the processor has to perform and the data cache includes data on which the operations may be performed.

The L2 cache may be larger in size than the L1 cache (e.g., the L1 cache may have a size such as 1 or 2 megabytes (MB), while the L2 cache may have a size such as 2 -32 MB). The L2 cache may be slower than the L1 cache but faster than random access memory (RAM) (e.g., the L2 cache may be 25 times faster than RAM). The L3 cache may be the largest cache (e.g., 128 MB) but may be slower than the L1 cache and L2 cache. The L3 cache may be shared between different processing cores within the computing system. For instance, the L3 cache may be shared by higher performance processing cores and lower performance processing cores.

Cache memories may be considered local memories. Cache memories may be incorporated with processing cores or may be located in close proximity to the processing cores. For instance, the L1 cache and L2 cache may be included in the processing core. The L3 cache may be included on a same chip, such as a system-on-a-chip (SoC) or another integrated circuit.

Cache memories may be built using static random access memory (SRAM) cells. SRAM cells may experience SRAM leakage power. SRAM leakage power refers to the power consumed by the SRAM cells even when the memory cells are not actively being accessed. The SRAM leakage power may be due to small currents that flow through the transistors in the SRAM cells, even when they are in a standby state.

Large system caches (e.g., 20 MB or more) may be used for some applications including (but not limited to) augmented reality SoCs due to stringent power targets. As cache size increases, the SRAM leakage power may also increase. In some conventional systems, the SRAM leakage power may account for as much as sixteen percent of the total use case power.

To address the SRAM leakage power and other issues, aspects of the present disclosure are directed to activity-based data RAM retention. In various aspects, system cache may be partitioned into power collapsible blocks (PCBs) (e.g., 64 kilobyte (KB) blocks). The activity for each PCB may be tracked and inactive PCBs may be placed in a sleep retention state. The PCB may wake up in response to an access to the PCB.

When the capacity of a cache memory is reached, data may have to be evicted (e.g., removed) to enable other data to be stored. Cache eviction and/or cache replacement policies may determine how to manage data in the cache, for instance, by retaining recent or often used data in the cache memory locations and other data in a main (global) memory. Conventional cache replacement policies may employ a least recently used (LRU) approach, a not most recently used (NMRU), or a pseudo-MRU replacement process to determine the data to be replaced. In doing so, the cache replacement policy may allocate (e.g., select) a way for the replacement. Each way may refer to a mapping between blocks of main memory and cache memory (e.g., cache lines). However, using conventional replacement policies may select the PCB that was most recently placed in the sleep retention state. Thus, employing conventional replacement policies may result in increased SRAM leakage power due in part to the increased power consumed in repeatedly waking inactive PCBs.

Accordingly, to address the SRAM leakage power and other issues, aspects of the present disclosure employ a power-aware cache replacement policy. In various aspects of the present disclosure, the power-aware cache replacement policy may prioritize replacement of data in active PCBs.

Particular aspects of the subject matter described in this disclosure can be implemented to realize one or more of the following potential advantages. In some examples, the described techniques (e.g., allocating a portion of the cache memory for replacement based on a power state of the portion of the cache memory) may increase sleep time of PCBs of the cache memory and reduce the SRAM leakage power, thermal dissipation and power dissipation of a mobile device (e.g., a smartphone or extended reality (XR) device).

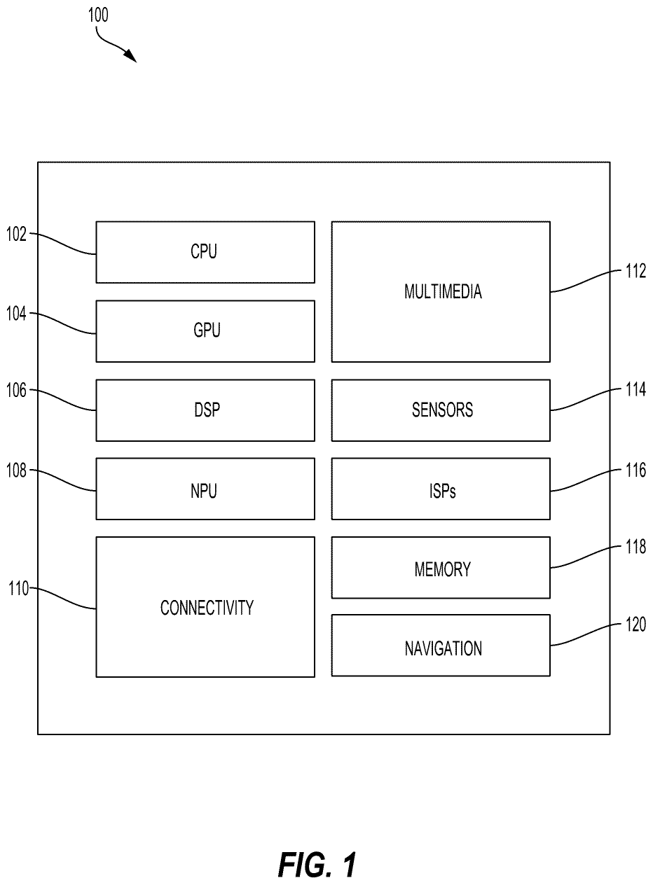

FIG. 1 illustrates an example implementation of a host system-on-a-chip (SoC) 100, which includes a controller for power-aware cache replacement, in accordance with various aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

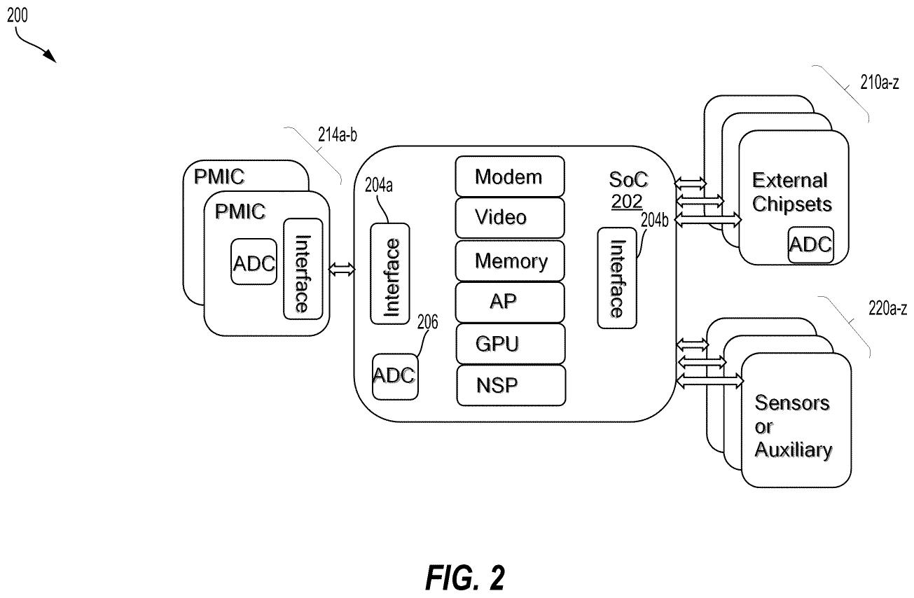

FIG. 2 is a block diagram illustrating an example computing system 200, in accordance with various aspects of the present disclosure. As shown in FIG. 2, the example computing system 200 may include a host SoC 202. The host SoC 202 may include similar components and function similar to SoC 100 (FIG. 1). As shown in FIG. 2, the host SoC 202 includes interface circuitry 204a-b and an ADC 206. The interface circuitry 204a-b may provide connectivity to one or more power management integrated circuits (PMICs) 214a-b. In addition, the interface circuitry may provide connectivity to one or more external chipsets 210a-z as well as external sensors or auxiliary integrated circuit devices 220a-z. In some aspects, the external chipsets 210a-z may for example include additional processors, such as one or more external GPUs 210 or one or more wireless communication devices that may facilitate communication such as 5G, 6G, vehicle-to everything communication (V2X), wireless local area network (WLAN), and the like. Moreover, in various aspects, the external chipsets 210a-z may, for example, relate to vehicle control and safety systems.

The sensors/auxiliary IC devices 220a-z may power sensors (e.g., digital power meters), thermal sensors, current sensors, voltage sensors, transmit power level sensors, The host SoC 202 may include a single ADC 206. The ADC 206 may periodically sample and monitor mixed signal such as internal on-chip current sensor and voltage sensor outputs. Additionally, the ADC 206 may periodically sample and monitor off-chip parameters such as sensor output parameters associated with the sensors/auxiliary IC devices 220a-z. In an example, the ADC 206 may receive an analog voltage signal (e.g., through the interface circuitry 204a) from a power supply (e.g., PMIC 214a-b), for example. The ADC 206 may digitally encode the analog signal to convert the analog voltage signal to a digital output. The ADC 206 may include both analog and digital circuits and thus, may be considered a mixed-signal integrated circuit. In some aspects, the ADC 206 may also convert other analog signal supplied to the computing system 200 to a digital output. For instance, the ADC 206 may convert analog signals from sensors (e.g., 114 of FIG. 1 or sensors/auxiliary IC devices 220a-z) such as temperature sensors, light sensors, sonar signal, video signals, gyroscope sensors and the like.

In some aspects, the ADC 206 may distribute the digital output to digital components of the computing system 200 using a bus transfer protocol such as the advanced microcontroller bus architecture (AMBA) advanced high-performance bus (AHB) protocol, for example.

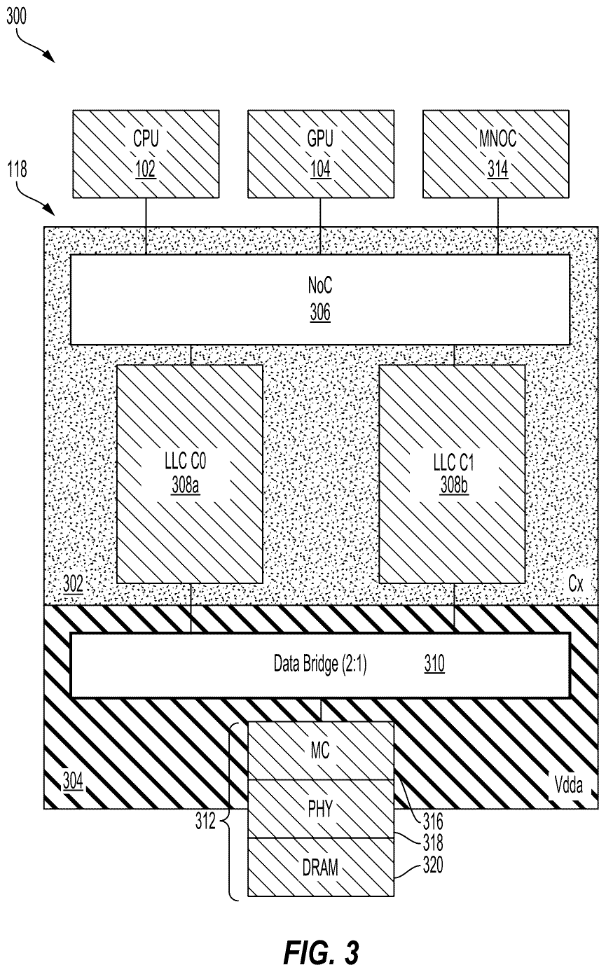

FIG. 3 is a block diagram illustrating an example architecture 300 of the memory 118 of the SoC 100 shown in FIG. 1, in accordance with various aspects of the present disclosure. Referring to FIG. 3, the example architecture 300 may be configured with multiple power domains such as a cache domain 302 and a main memory domain 304. In the cache domain 302, the example architecture 300 may include a first network-on-a-chip (NoC) 306 and cache memories (e.g., last level caches) LLC C0 (308a) and LLC C1 (308b). The first NoC 306 may comprise a communication subsystem for the SoC (e.g., 100) that facilitates data transfers between the components of the SoC. For example, the first NoC 306 may facilitate data transfers between processors such as the CPU 102 and the GPU 104 and/or a multimedia NoC 314 and the cache memories 308a, 308b.

In the main memory domain 304, the example architecture 300 may include a data bridge 310 and a main memory 312. The main memory 312 may include a memory controller (MC) 316, dynamic random-access memory (DRAM) 320 and a physical layer (PHY) 320, which may serve as a physical interface between the MC 316 and the memory modules of the DRAM 320.

The data bridge 310 (e.g., Northbridge) may serve as an interface between the cache memories 308a and 308b and the main memory. The MC 316 may manage the flow of data (e.g., reading data, writing data, or refreshing DRAM cells) between main memory 312 and the cache memory (e.g., 308a or 308b).

The data bridge 310 and MC 316 may be included in the main memory power domain 304 and receive an external analog power supply voltage (Vdda). On the other hand, the cache memories 308a, 308b may reside in the cache power domain 302 and may receive a second power supply voltage (Cx), which may, for example, be configured via the ADC 206.

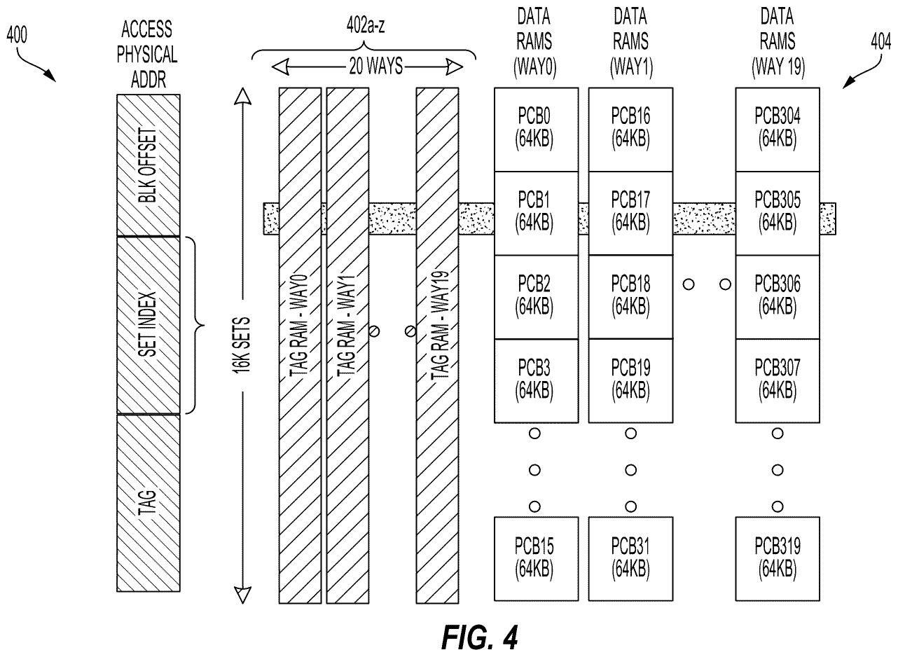

FIG. 4 is a block diagram illustrating an example memory layout 400 of cache memories, in accordance with various aspects of the present disclosure. The example memory layout 400 of cache memories (e.g., 308a, 308b) may include a set of Tag RAM 402a-z and corresponding data RAM 404. For instance, as shown in FIG. 4, the cache memories (e.g., 308a) may include 20 ways, each of which includes a Tag RAM. Each way may refer to a mapping between blocks of main memory and cache memory (e.g., cache lines). A Tag RAM may be a type of SRAM that stores the addresses of data stored in cache. That is, each Tag RAM may hold the address (also referred to as a tag) of the data stored in the cache lines (e.g., data RAM 404).

A cache controller (e.g., MC 316) may use the Tag RAM to determine if data requested by a processor (e.g., CPU 102) is stored in cache. If the data is stored in cache, the access may be considered a cache hit. When the data is not stored in the cache, the attempted access may be deemed a cache miss, and data may then be fetched from main memory (e.g., DRAM 320).

The data RAM 404, like the set of Tag RAM 402a-z, may be divided into a number of ways (e.g., 20 ways). In addition, each way of the data RAM 404 may be partitioned into a set of power collapsible blocks (PCBs). A PCB may comprise a group memory cells of data RAM 404 that can be collapsed together. Each PCB may, for instance, have a size of 64 KB. The group of memory cells of a PCB may include two SRAMs (e.g., 32 KB each), for example.

In accordance with aspects of the present disclosure, access activity may be tracked for each PCB. Then, when a PCB (404) is determined to be inactive, the PCB may be placed into a sleep retention state. On the other hand, the PCB (404) may wake up in response to a hardware access to the PCB in the sleep retention state.

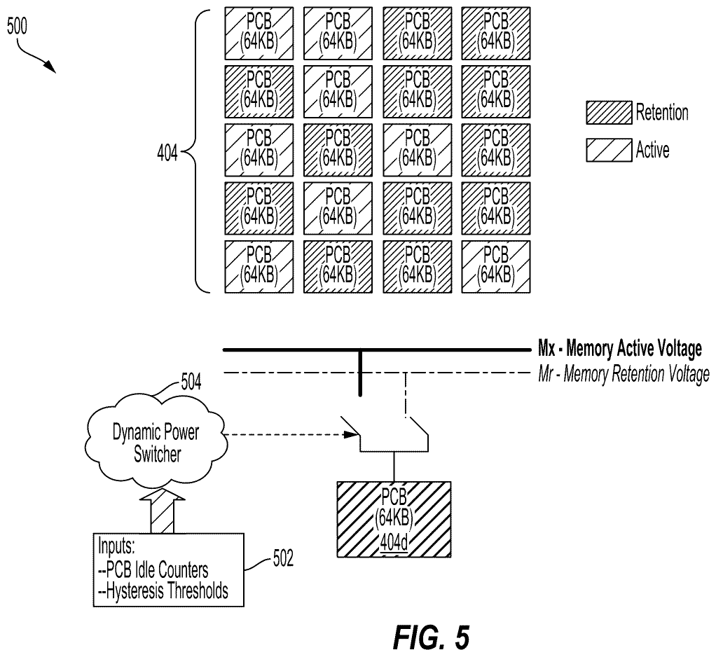

FIG. 5 is a block diagram illustrating an example implementation 500 of activity-based data RAM retention, in accordance with various aspects of the present disclosure. Referring to FIG. 5, a set of PCBs of the data RAM 404 are shown.

The activity of each PCB may be tracked. Based on the activity, the PCB may be determined to be active. On the other hand, when the PCB is determined to be inactive, the PCB may be selectively retention-collapsed. Retention-collapsed refers to putting the SRAM of the PCB (e.g., 404d) into the sleep state by collapsing a peripheral circuit voltage (e.g., memory active voltage (Mx)) and not collapsing a bit cell core voltage (e.g., memory retention voltage (Mr)).

The power state transitions may be managed by a finite state machine (FSM). In some aspects, the transitions may be managed using an FSM for each PCB. An activity counter may count an inactivity period for each PCB. For example, when an access is reissued or stalled in an inflight buffer, a target PCB may be considered to be in an inactive state.

Inflight buffers may aid in management of data being transferred between processors (e.g., CPU 102 or GPU 104 of FIG. 3) and main memory (e.g., 320) or cache memory (e.g., PCB 404d). Inflight buffers may increase efficiency in the flow of data and reduce processing latency. Inflight buffers may, for example, include read buffers or write buffers. Read buffers may hold data that has been fetched from main memory (e.g., 320) that has not yet been processed by a processor (e.g., CPU 102 or GPU 104). Write buffers may hold data that is being written to memory (e.g., PCB 404d or DRAM 320). Write buffers may enable the processor (e.g., CPU 102 or GPU 104) to proceed with other tasks without waiting for the write operation to complete.

Accordingly, data held in an inflight buffer that is directed to/from cache memory (e.g., PCB 404d) may indicate activity/use of the cache memory.

The inactivity of the PCB may trigger an activity counter (e.g., an idle counter) to begin counting clock cycles of inactivity. The activity counter may be supplied to a RAM sleep controller 502. In various aspects, the RAM sleep controller 502 may comprises a separate hardware component/module/logic or may be a separate hardware component/module/logic included within the MC 316. The RAM sleep controller 502 that monitors the traffic to the memory (e.g., 404 and 312) and maintains the status (e.g., active/sleep) of the PCBs (404).

Each of the PCBs (e.g., 404d) may be coupled to a power source by a dynamic power switcher 504 controlled by the RAM sleep controller 502. When the PCB (e.g., 404d) is determined to be active, the RAM sleep controller 502 may control the dynamic power switcher 504 to couple the PCB (e.g., 404d) to a memory active power voltage source (Mx). Conversely, when the PCB (e.g., 404d) is determined to be inactive (e.g., idle counter >hysteresis threshold), the RAM sleep controller 502 may control the dynamic power switcher 504 to decouple the PCB (e.g., 404d) from the memory active power voltage source (Mx). The hysteresis threshold may, for instance, comprise a programmable time limit (e.g., clock cycles) for which the RAM sleep controller 502 waits to declare inactivity for a PCB. The RAM sleep controller 502 may control the dynamic power switcher 504 to transition the PCB (e.g., 404d) to a sleep retention state receiving power by coupling the PCB to the memory retention voltage source (Mr).

In some aspects, a customized sleep mode (e.g., light sleep mode) may be employed to provide faster wakeup time for additional leakage savings. That is, some conventional SRAM may take a number of cycles to perform the wake up (e.g., 20 nanoseconds (ns)+dummy cycles (e.g., clock cycles in which no data is written)).

When the customized sleep mode is employed, the SRAM may wake up faster (e.g., 10 ns+dummy cycles).

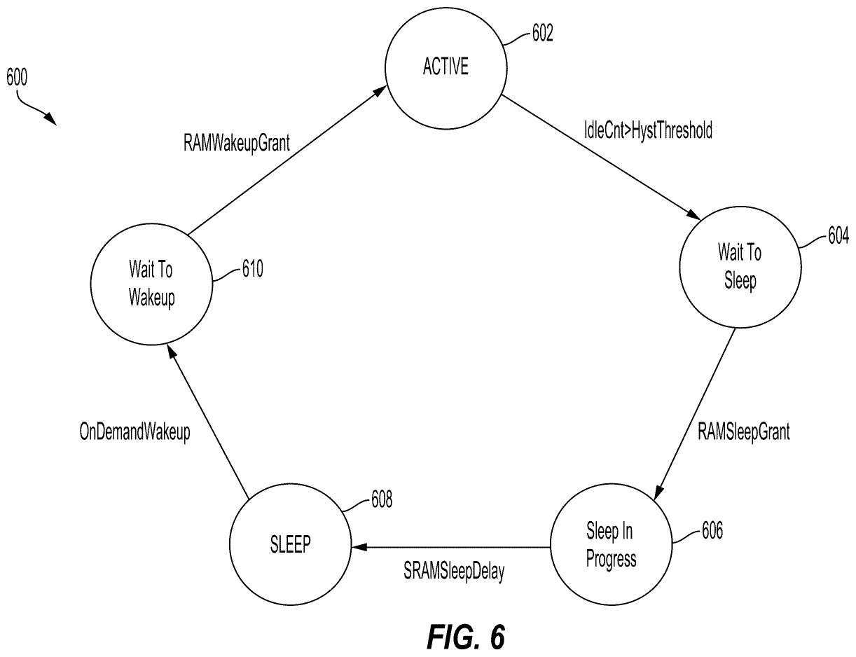

FIG. 6 is a block diagram illustrating an example power state finite state machine (FSM) 600, in accordance with various aspects of the present disclosure. In a first stage 602, a PCB may be in an active state. For instance, at power on, a PCB may be initialized and placed in the active state. As the memory traffic starts, the inflight counter of the PCB may be incremented. The inflight counter is the number of inflight accesses (e.g., an attempt to read data from or write data to the cache) or fills (e.g., loading data into the cache from main memory) for the PCB. If the inflight counter becomes zero, e.g., no access or fill for the particular PCB, an idle counter may trigger to start counting a number of idle cycles.

When the idle counter exceeds a threshold (e.g., hysteresis threshold), at a second stage 604, the FSM 600 may enter a wait-to-sleep state. A request may be sent for the RAM corresponding to the PCB to enter the sleep retention state. The request to enter the sleep retention state may be sent to a RAM sleep controller (e.g., 502).

If the sleep retention request is granted, the cache controller (e.g., MC 316) may respond by sending a RAM sleep grant to initiate sleep. In turn, at a third stage 606, the FSM 600 may enter a sleep in progress state. An SRAM sleep delay sequence may be sent to put the SRAM to sleep. At a fourth stage 608, the FSM 600 may enter a sleep state. That is, the dynamic switcher may be triggered to open a switch decoupling the PCB from the memory active voltage (Mx).

The PCB may wake on demand. When there is an access directed to the PCB, a wakeup request may be triggered. At a fifth stage 610, the FSM 600 may enter a wait to wakeup state. A wake up request may be sent to the RAM sleep controller (e.g., 502). The RAM sleep controller (e.g., 502) may initiate the SRAM (e.g., SRAM of a PCB 404) to start a wakeup cycle. When the wakeup is complete, the RAM controller may send a Wakeup grant. Then, the FSM 600 may return to the active state (at the first stage 602).

In some aspects, an occupancy counter may also be employed to determine when a PCB may be placed in the idle state. The occupancy counter may track the number of valid lines in a PCB. In some examples, the occupancy counter and the idle counter may be aggregated and compared to the threshold. If the aggregate exceeds the threshold, then FSM for the PCB may transition from the active state (602) to the wait-to-sleep state (604).

Additionally, further enhancement may be realized using separate wakeup priorities for reduce the wakeup latency. For example, separate wakeup first in first out queues (FIFOs) may be used for fills, reads, and writes. In some aspects, multiple PCBs (404) may be awakened at the same time. For instance, the PCBs (e.g., 404) may be wakeup by different types of requests to the cache such as reads, write, cache evictions and/or line fills (e.g., fetch from the main memory 312). Each type of transaction may have a separate queue (FIFO) and each queue may have a fixed grant priority in case of multiple wake-up requests from different request types.

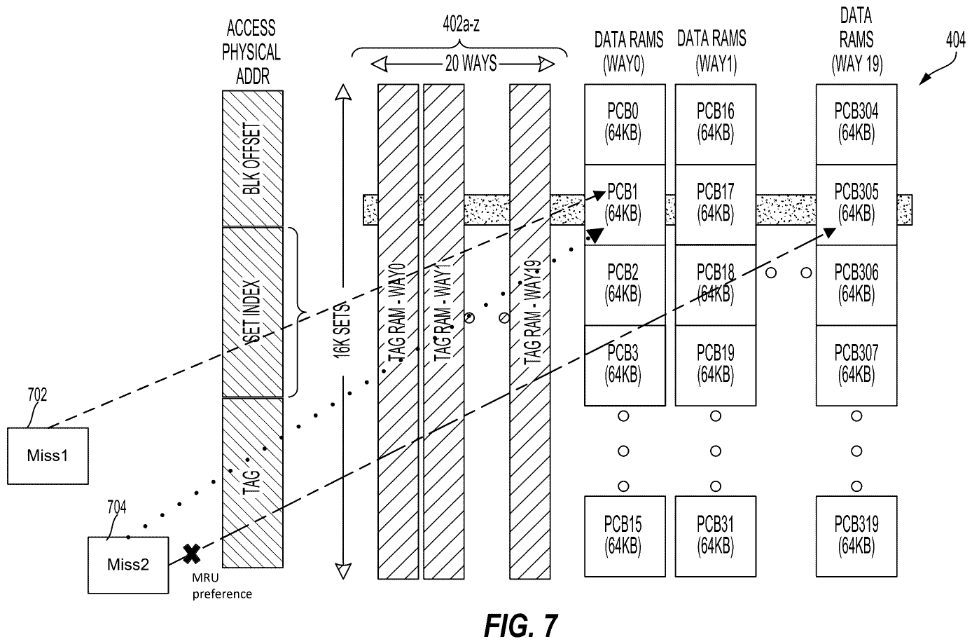

FIG. 7 is a block diagram illustrating an example of power-aware cache replacement, in accordance with various aspects of the present disclosure. As shown in FIG. 7, the example memory layout 400 (shown in FIG. 4) of cache memories (e.g., 308a, 308b) including the data RAM 404 may operate to perform various data transactions associated with one or more processors (e.g., 102, 104, or 108). A first cache miss (Miss1) 702 may be encountered. A cache miss refers to an event in which a processing core or application requests to retrieve specific data from a cache, but the specific data is not currently in cache memory. Thus, the specific data may have to be fetched from main memory (e.g., 312).

The data RAM 404 may be checked for a PCB in an active state. For example, a status vector indicating the state of each PCB of data RAM 404 may be maintained in hardware such as the RAM sleep controller 502, for instance. Each bit of the status vector may correspond to a PCB of the data RAM 404. When a cache miss is determined, the status vector may be checked to determine a set of active PCBs.

In the example of FIG. 7, at the time of the first cache miss (Miss1) 702, the PCBs of data RAM 404 may be in a sleep state, and thus may be considered inactive. Because there are no active PCBs at the time of Miss 1 702, a PCB (e.g., PCB 1) may be awakened. The requested data associated with Miss 1 702 may be fetched from the main memory, copied, and stored in (may also be referred to as a “fill”) the PCB1. At a later time, a second cache miss (Miss 2) 704 may be encountered. At the time of Miss 2 704, PCB 305 may be in a sleep state and may be determined to be the least recently used (LRU) PCB or not the most recently used (NMRU) PCB. As such, conventional cache replacement policy would select and allocate PCB305 for the requested data associated with Miss 2 704. However, because PCB 305 is in a sleep state, allocating the Miss 2 704 on PCB 305 may result in increased memory leakage power. Thus, to reduce memory leakage power, in accordance with aspects of the present disclosure, the data associated with Miss2 may be allocated to a PCB that is already active. In the example of FIG. 7, the data associated with Miss2 may be allocated to PCB1.

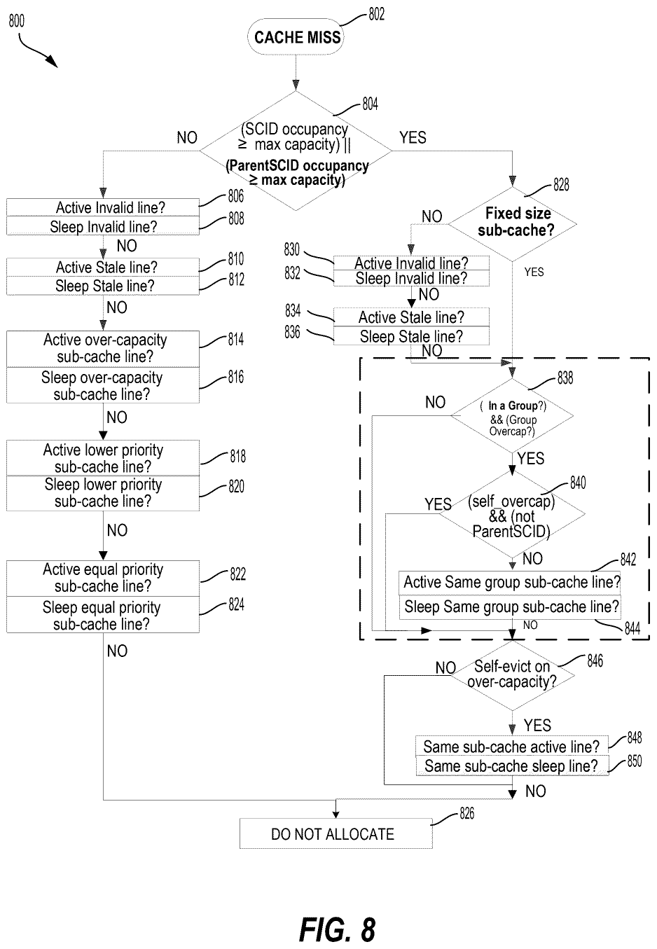

FIG. 8 is a flow diagram illustrating an example process 800 for power-aware cache replacement, in accordance with various aspects of the present disclosure. Referring to FIG. 8, the example process 800 may be initiated in response to a cache miss at block 802.

At block 804, a sub-cache identifier (SCID) occupancy for a data transaction associated with the cache miss may be compared to a maximum capacity level of the cache line. A sub-cache may be considered a subset of the cache memory such as sub-bank of the cache. The sub-cache may comprise a set of ways, each of which includes a set of cache lines for example. That is, the SCID occupancy may be compared to maximum capacity of a cache line of a way, a PCB, or an SRAM within a PCB, for example. If the SCID occupancy is less than the maximum capacity (e.g., 64 KB or 32 KB) or a parent SCID occupancy is less than the maximum capacity, then the example process 800 may proceed to block 806. An allocation sequence (e.g., 806-824) may be performed to determine a PCB allocation. The allocation sequence may have a two-tier priority. A first tier may consider allocating a PCB for cache replacement according to a priority order of an invalid line (806, 808)→stale line (810, 812)→an over-capacity sub-cache line (814, 816)→a lower priority sub-cache line (818, 820)→equal priority sub-cache line.

A cache line may be considered a smallest portion of data that may be mapped into a cache memory. A cache line may be considered invalid when the cache memory location has been cleared of data by resetting the valid bit for the cache line. A cache line may be considered stale if the data (e.g., PCB) in the cache is out of date with respect to the associated data in main memory. In some aspects, a cache line may be considered stale if the cache line has been allocated but a client has indicated that such cache line may not be used in the future and may be considered de-activated.

With respect to the over-capacity sub-cache line priority level (e.g., 814, 816), the system cache may be partitioned into sub-caches with a predetermined capacity according to a client specification. When a particular client has allocated more than the predetermined capacity of the sub-cache line, an overcapacity sub-cache line occurs.

Additionally, each data transaction (associated with the cache miss) may be assigned a priority. For example, data that may be used frequently may have a higher priority than data that may be used less frequently.

In accordance with aspects of the present disclosure, a second tier of the priority may be employed. In the second tier, a preference for PCBs that are in an active state rather than a sleep state may be applied. By way of example, but not limitation, at each level in the allocation sequence (e.g., invalid line, stale line, overcapacity sub-cache, lower priority sub-cache or equal priority sub-cache), active PCBs may have a higher priority than inactive PCBs. Accordingly, at block 806, the example process 800 may determine if there is an active invalid line in a PCB. If there is an active invalid line in a PCB, then the PCB may be allocated for the data replacement. If there is no active invalid line, at block 808, the example process 800 may determine whether there is a sleep invalid line. For purpose of clarity, an active line may be considered to be a line in an active PCB (e.g., PCB1 of FIG. 7) and sleep line to be a line in a PCB (e.g., PCB305 of FIG. 7) that is in sleep retention.

If there is an invalid line in a PCB that is in the sleep retention state, then such PCB may be allocated for the data replacement. If there is no sleep invalid line, the example process 800 continues and at block 810, the example process 800 may determine whether there is an active stale line. If there is a stale line in a PCB that is in the active state, then such PCB may be allocated for the data replacement. On the other hand, if there is no active stale line, at block 812, the example process 800 may determine whether there is a sleep stale line. If there is a stale line in a PCB that is in the sleep retention state, then such PCB may be allocated for the data replacement. However, if there is no sleep stale line, then the example process 800 continues and at block 814, the example process 800 may determine whether there is an active over-capacity sub-cache line.

The example process 800 may continue in similar fashion to determine a cache replacement by considering for each subsequent level in the first tier priority order (e.g., over-capacity sub-cache line, lower-priority sub-cache line, and equal priority sub-cache line), the preference for PCBs in the active state over PCBs in the sleep retention state. If an allocation has not been made after considering each level of the allocation sequence (e.g., 806-824), then a replacement allocation may not be made (block 826).

If after determining that a cache miss has occurred at block 802, and the SCID occupancy is greater than or equal to the maximum capacity (804: YES), the example process 800 may, at block 828, determine whether the sub-cache (predefined) has a fixed sized. If the sub-cache does not have a fixed size (e.g., the capacity can be increased), then at block 830, the example process 800 may check for an active invalid cache line, followed by a sleep invalid cache line (at block 832), active stale line (block 834), and sleep stale line (block 836) in a manner similar to blocks 806-812.

If a cache line has not been allocated (following block 836) or, the sub-cache has fixed size (block 828: YES), the example process 800 may continue at block 838.

At block 838, the example process 800 may determine whether the sub-cache (SCID) is included in a group. Multiple SCIDs may be grouped together. For example, there may be three processors in a CPU, and each processor may have a different sub-cache capacity that may be grouped together, but the total capacity may not cross a threshold (e.g., 4MB). If the sub-cache is a group and the group is over the maximum capacity, then at block 840, each sub-cache in the group may be evaluated to determine whether such sub-cache is a parent sub-cache. Parent subcache may refer to a sub-cache in a group that has the highest priority (may also be referred to a the “group leader”). If a sub-cache of the group is not a parent sub-cache, the example process 800 may determine whether the is an active line in the same group sub-cache (block 842) for allocation. If there is no active line in the same group sub-cache, at block 844, the example process 800 may determine whether there is a sleep line in the same group sub-cache for allocation.

If the sub-cache is a parent sub-cache (block 840) or no allocation has been made after considering block 844, the example process 800 may continue. At block 846, the example process 800 may determine whether the sub-cache (SCID) may self-evict if over capacity. If the self-evict is available, then at block 848, the example process 800 may determine if there is a same sub-cache active line (block 848) for allocation. If there is not a same sub-cache active line, the example process 800 may then determine whether there is a same sub-cache sleep line for allocation (block 850). If, however, self-eviction on over capacity is not available (block 848) or there has not been a cache line allocation after considering block 850, then an allocation may not be made (block 826). Self-eviction on over capacity refers to a scenario in which an incoming access for a sub-cache (SCID) finds the sub-cache to be full and a previously allocated line belonging to the same sub-cache has to be evicted. The sub-cache may then self evict one of previously allocated lines to make space for the new incoming line.

In some aspects, a line may also be selected for eviction that may be considered clean. That is, a cache line may be considered clean if it has not been modified since being loaded from the main memory. In this case, the new cache line may simply overwrite the selected line. In another scenario, the line selected for eviction may be considered dirty. A cache line may be considered dirty if it has been modified since being loaded from the main memory. In this scenario, the selected line may be read from the cache and written into DRAM/main memory (may also referred to as flushing the cache line). Subsequently, the new line may overwrite the selected line in the cache.

Accordingly, aspects of the present disclosure may beneficially reduce, and in some aspects, significantly reduce the data RAM leakage power.

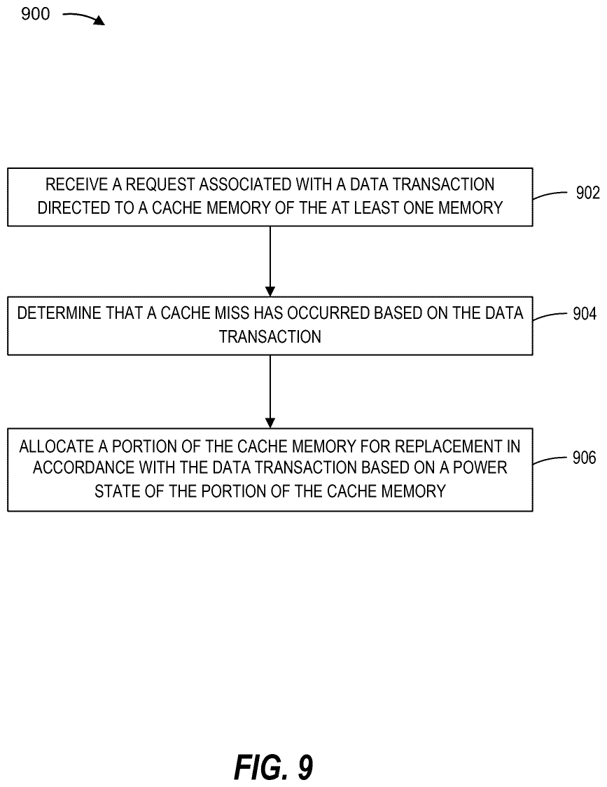

FIG. 9 is a flow diagram illustrating an example process 900 performed, for example, by a processor, in accordance with various aspects of the present disclosure. The process 900 is an example of power-aware cache replacement. The process 700 may be performed by a memory management unit such as the RAM sleep controller 502 or the memory controller 316, for example.

As shown in FIG. 9, at block 902, the memory management unit receives a request associated with a data transaction directed to a cache memory of the at least one memory. As described with respect to FIG. 7, a processing core or application may request to retrieve specific data from a cache memory (e.g., data RAM 404).

At block 904, the memory management unit determines that a cache miss has occurred based on the data transaction. For instance, as described with reference to FIG. 7, a first cache miss (Miss1) 702 may be encountered. A cache miss refers to an event in which specific data requested from a cache by a processing core or application is not currently in cache memory.

At block 906, the memory management unit allocates a portion of the cache memory for replacement in accordance with the data transaction based on a power state of the portion of the cache memory. As described, for example, with reference to FIG. 7, The data RAM 404 may be checked for a PCB in an active state. For example, a status vector indicating the state of each PCB of data RAM 404 may be maintained in hardware such as the RAM sleep controller 502, for instance. Each bit of the status vector may correspond to a PCB of the data RAM 404. When a cache miss is determined, the status vector may be checked to determine a set of active PCBs.

At the time of the first cache miss (Miss1) 702, the PCBs of data RAM 404 may be in a sleep state, and thus may be considered inactive. Because there are no active PCBs at the time of Miss 1 702, a PCB (e.g., PCB1) may be awakened. The requested data associated with Miss 1 702 may be fetched from the main memory, copied, and stored in (may also be referred to as a “fill”) the PCB1.

In another example, a second cache miss (Miss 2) 704 may be encountered at a later time. At the time of Miss 2 704, PCB 305 may be in a sleep state and may be determined to be the least recently used (LRU) PCB or not the most recently used (NMRU) PCB. As such, conventional cache replacement policy would select and allocate PCB 305 for the requested data associated with Miss 2 704. However, because PCB 305 is in a sleep state, allocating the Miss 2 704 on PCB 305 may result in increased memory leakage power. Thus, to reduce memory leakage power, in accordance with aspects of the present disclosure, the data associated with Miss2 may be allocated to a PCB that is already active. Accordingly, the data associated with Miss2 may be allocated to PCB1.

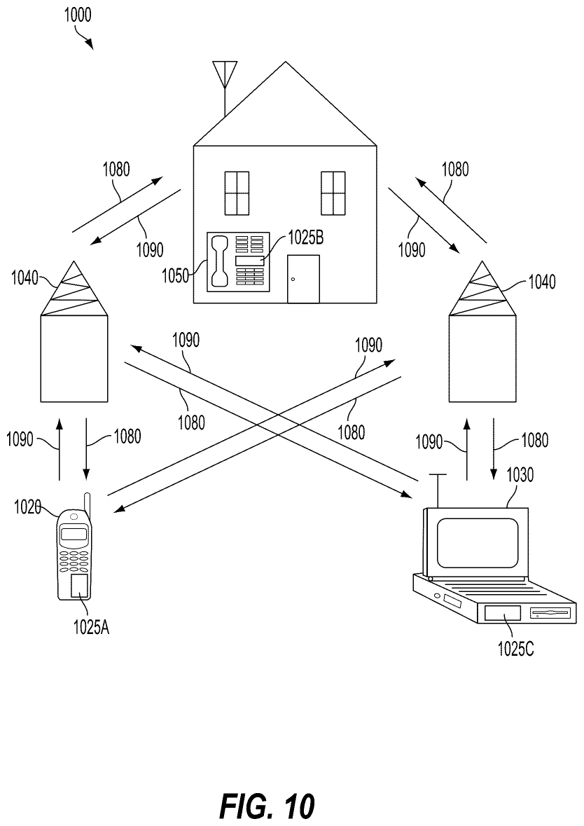

FIG. 10 is a block diagram showing an exemplary wireless communications system 10, in which an aspect of the present disclosure may be advantageously employed. For purposes of illustration, FIG. 10 shows three remote units 1020, 1030, and 1050, and two base stations 1040. It will be recognized that wireless communications systems may have many more remote units and base stations. Remote units 1020, 1030, and 1050 include integrated circuit (IC) devices 1025A, 1025B, and 1025C that include the disclosed activity-based retention system with power-aware cache replacement. It will be recognized that other devices may also include the disclosed bus traffic reduction system such as the base stations, switching devices, and network equipment. FIG. 10 shows forward link signals 1080 from the base stations 1040 to the remote units 1020, 1030, and 1050, and reverse link signals 1090 from the remote units 1020, 1030, and 1050 to the base stations 1040.

In FIG. 10, remote unit 1020 is shown as a mobile telephone, remote unit 1030 is shown as a portable computer, and remote unit 1050 is shown as a fixed location remote unit in a wireless local loop system. For example, the remote units may be a mobile phone, a hand-held personal communication systems (PCS) unit, a portable data unit, such as a personal data assistant, extended reality system, an augmented reality system, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 10 illustrates remote units according to the aspects of the present disclosure, the disclosure is not limited to these exemplary illustrated units. Aspects of the present disclosure may be suitably employed in many devices, which include the disclosed bus traffic reduction system.

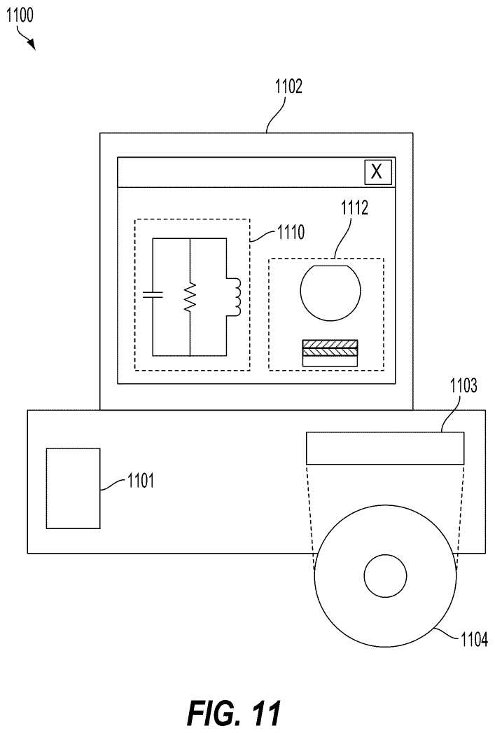

FIG. 11 is a block diagram illustrating a design workstation 1100 used for circuit, layout, and logic design of a semiconductor component, such as the RAM sleep controller 502 disclosed above. The design workstation 1100 includes a hard disk 1101 containing operating system software, support files, and design software such as Cadence or OrCAD. The design workstation 1100 also includes a display 1102 to facilitate design of a circuit 1110 or a semiconductor component 1112, such as the RAM sleep controller 502. A storage medium 1104 is provided for tangibly storing the design of the circuit 1110 or the semiconductor component 1112 (e.g., RAM sleep controller 502). The design of the circuit 1110 or the semiconductor component 1112 RAM sleep controller 502) may be stored on the storage medium 1104 in a file format such as GDSII or GERBER. The storage medium 1104 may be a CD-ROM, DVD, hard disk, flash memory, or other appropriate device. Furthermore, the design workstation 1100 includes a drive apparatus 1103 for accepting input from or writing output to the storage medium 1104.

Data recorded on the storage medium 1104 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1104 facilitates the design of the circuit 1110 or the semiconductor component 1112 by decreasing the number of processes for designing semiconductor wafers.

### EXAMPLE ASPECTS

Aspect 1: An apparatus, comprising: at least one memory; and a memory management unit coupled to the at least one memory, the memory management unit configured to: receive a request associated with a data transaction directed to a cache memory of the at least one memory; determine that a cache miss has occurred based on the data transaction; and allocate a portion of the cache memory for replacement in accordance with the data transaction based on a power state of the portion of the cache memory.

Aspect 2: The apparatus of Aspect 1, in which the cache memory is partitioned into multiple power collapsible blocks (PCBs), each of the multiple PCBs being operable in an active power state or a sleep retention power state.

Aspect 3: The apparatus of Aspect 1 or 2, in which the memory management unit is further configured to allocate a cache line among the multiple PCBs based on a preference for a PCB in the active power state.

Aspect 4: The apparatus of any preceding Aspect, in which the memory management unit is further configured to allocate the cache line among the multiple PCBs in a first PCB in the sleep retention power state when none of the multiple PCBs are in the active power state.

Aspect 5: The apparatus of any preceding Aspect, in which the memory management unit is further configured to initiate a wake up of the first PCB in the sleep retention power state in response to allocating the cache line in the first PCB.

Aspect 6: The apparatus of any preceding Aspect, in which the memory management unit is further configured to allocate the portion of the cache memory for replacement based on whether the portion includes one or more of invalid cache lines, or stale cache lines.

Aspect 7: The apparatus of any preceding Aspect, in which the data transaction is associated with a sub-cache identifier and the memory management unit is further configured to allocate the portion of the cache memory for replacement based on a priority level for the sub-cache identifier.

Aspect 8: A processor-implemented method performed by one or more processors, the processor-implemented method, comprising: receiving a request associated with a data transaction directed to a cache memory of the at least one memory; determining that a cache miss has occurred based on the data transaction; and allocating a portion of the cache memory for replacement in accordance with the data transaction based on a power state of the portion of the cache memory.

Aspect 9: The processor-implemented method of Aspect 8, in which the cache memory is partitioned into multiple power collapsible blocks (PCBs), each of the multiple PCBs being operable in an active power state or a sleep retention power state.

Aspect 10: The processor-implemented method of Aspect 8 or 9, further comprising allocating a cache line among the multiple PCBs based on a preference for a PCB in the active power state.

Aspect 11: The processor-implemented method of any of Aspects 8-10, further comprising allocating the cache line among the multiple PCBs in a first PCB in the sleep retention power state when none of the multiple PCBs are in the active power state.

Aspect 12: The processor-implemented method of any of Aspects 8-11, further comprising initiating a wake up of the first PCB in the sleep retention power state in response to allocating the cache line in the first PCB.

Aspect 13: The processor-implemented method of any of Aspects 8-12, further comprising allocating the portion of the cache memory for replacement based on whether the portion includes one or more of invalid cache lines, or stale cache lines.

Aspect 14: The processor-implemented method of any of Aspects 8-13, in which the data transaction is associated with a sub-cache identifier and the processor-implemented method further comprises allocating the portion of the cache memory for replacement based on a priority level for the sub-cache identifier.

Aspect 15: An apparatus, comprising: means for receiving a request associated with a data transaction directed to a cache memory of the at least one memory; means for determining that a cache miss has occurred based on the data transaction; and means for allocating a portion of the cache memory for replacement in accordance with the data transaction based on a power state of the portion of the cache memory.

Aspect 16: The apparatus of Aspect 15, in which the cache memory is partitioned into multiple power collapsible blocks (PCBs), each of the multiple PCBs being operable in an active power state or a sleep retention power state.

Aspect 17: The apparatus of Aspect 15 or 16, further comprising means for allocating a cache line among the multiple PCBs based on a preference for a PCB in the active power state.

Aspect 18: The apparatus of any of Aspects 15-17, further comprising means for allocating the cache line among the multiple PCBs in a first PCB in the sleep retention power state when none of the multiple PCBs are in the active power state.

Aspect 19: The apparatus of any of Aspects 15-18, further comprising means for initiating a wake up of the first PCB in the sleep retention power state in response to allocating the cache line in the first PCB.

Aspect 20: The apparatus of any of Aspects 15-19, in which the data transaction is associated with a sub-cache identifier and the apparatus further comprises means for allocating the portion of the cache memory for replacement based on a priority level for the sub-cache identifier.

In one aspect, the receiving means, determining means and/or allocating means may be the RAM sleep controller 502 and/or MC 316 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device.

Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

1. An apparatus, comprising:
at least one memory; and
a memory management unit coupled to the at least one memory, the memory management unit configured to:
receive a request associated with a data transaction directed to a cache memory of the at least one memory;
determine that a cache miss has occurred based on the data transaction; and
allocate a portion of the cache memory for replacement in accordance with the data transaction based on a power state of the portion of the cache memory, by prioritizing allocation to a first portion in an active power state over a second portion in a sleep retention power state, the allocation occurring responsive to the cache miss.

2. The apparatus of claim 1, in which the cache memory is partitioned into multiple power collapsible blocks (PCBs), each of the multiple PCBs being operable in the active power state or the sleep retention power state.

3. The apparatus of claim 2, in which the memory management unit is further configured to allocate a cache line among the multiple PCBs based on a preference for a PCB in the active power state.

4. The apparatus of claim 3, in which the memory management unit is further configured to allocate the cache line among the multiple PCBs in a first PCB in the sleep retention power state when none of the multiple PCBs are in the active power state.

5. The apparatus of claim 4, in which the memory management unit is further configured to initiate a wake up of the first PCB in the sleep retention power state in response to allocating the cache line in the first PCB.

6. The apparatus of claim 1, in which the memory management unit is further configured to allocate the portion of the cache memory for replacement based on whether the portion includes one or more of invalid cache lines, or stale cache lines.

7. The apparatus of claim 1, in which the data transaction is associated with a sub-cache identifier and the memory management unit is further configured to allocate the portion of the cache memory for replacement based on a priority level for the sub-cache identifier.

8. A processor-implemented method performed by one or more processors, the processor-implemented method, comprising:
receiving a request associated with a data transaction directed to a cache memory of the at least one memory;
determining that a cache miss has occurred based on the data transaction; and
allocating a portion of the cache memory for replacement in accordance with the data transaction based on a power state of the portion of the cache memory, by prioritizing allocation to a first portion in an active power state over a second portion in a sleep retention power state, the allocation occurring responsive to the cache miss.

9. The processor-implemented method of claim 8, in which the cache memory is partitioned into multiple power collapsible blocks (PCBs), each of the multiple PCBs being operable in the active power state or the sleep retention power state.

10. The processor-implemented method of claim 9, further comprising allocating a cache line among the multiple PCBs based on a preference for a PCB in the active power state.

11. The processor-implemented method of claim 10, further comprising allocating the cache line among the multiple PCBs in a first PCB in the sleep retention power state when none of the multiple PCBs are in the active power state.

12. The processor-implemented method of claim 11, further comprising initiating a wake up of the first PCB in the sleep retention power state in response to allocating the cache line in the first PCB.

13. The processor-implemented method of claim 8, further comprising allocating the portion of the cache memory for replacement based on whether the portion includes one or more of invalid cache lines, or stale cache lines.

14. The processor-implemented method of claim 8, in which the data transaction is associated with a sub-cache identifier and the processor-implemented method further comprises allocating the portion of the cache memory for replacement based on a priority level for the sub-cache identifier.

15. An apparatus, comprising:
means for receiving a request associated with a data transaction directed to a cache memory of the at least one memory;
means for determining that a cache miss has occurred based on the data transaction; and
means for allocating a portion of the cache memory for replacement in accordance with the data transaction based on a power state of the portion of the cache memory, by prioritizing allocation to a first portion in an active power state over a second portion in a sleep retention power state, the allocation occurring responsive to the cache miss.

16. The apparatus of claim 15, in which the cache memory is partitioned into multiple power collapsible blocks (PCBs), each of the multiple PCBs being operable in the active power state or the sleep retention power state.

17. The apparatus of claim 16, further comprising means for allocating a cache line among the multiple PCBs based on a preference for a PCB in the active power state.

18. The apparatus of claim 17, further comprising means for allocating the cache line among the multiple PCBs in a first PCB in the sleep retention power state when none of the multiple PCBs are in the active power state.

19. The apparatus of claim 18, further comprising means for initiating a wake up of the first PCB in the sleep retention power state in response to allocating the cache line in the first PCB.

20. The apparatus of claim 15, in which the data transaction is associated with a sub-cache identifier and the apparatus further comprises means for allocating the portion of the cache memory for replacement based on a priority level for the sub-cache identifier.
